(19) United States
(12) Patent Application Publication
(10) Pub. No.: US 2022/0125133 A1
(43) Pub. Date: Apr. 28, 2022

(54) THREE-DIMENSIONAL MASK WITH AN EXPRESSION WINDOW, AND A MANUFACTURING METHOD AND PRODUCTION EQUIPMENT THEREOF

(71) Applicant: TAIWAN COMFORT CHAMP MANUFACTURING CO., LTD., Taoyuan City (TW)

(72) Inventor: Yung-Chih CHEN, Taoyuan City (TW)

(21) Appl. No.: 17/146,934

(22) Filed: Jan. 12, 2021

(30) Foreign Application Priority Data
Oct. 22, 2020 (TW) 109136717

(51) Int. Cl. A41D 13/11

(52) U.S. Cl. CPC A41D 13/113; A41D 2300/50; A41D 13/1161

(57) ABSTRACT

The present invention discloses a three-dimensional mask with an expression window, and a manufacturing method and production equipment thereof; wherein a three-dimensional mask that splits open toward left and right as a bulge is provided for wearing. In a shielding region of mask body corresponding to a user's mouth, a refractive diaphragm is replaceably and tightly disposed and is expanded associatively following a preparation operation, so that a person with whom the user communicates can see through the expression of the user's mouth and the verbal the user manifests. Therefore, a three-dimensional mask for context communication and a coherent manufacturing method and production equipment thereof are provided, with some devices of the production equipment being able to be adapted in a same working region.

### BACKGROUND OF THE INVENTION

### a) Field of the Invention

The present invention relates to a three-dimensional mask with an expression window, and a manufacturing method and production equipment thereof; wherein a three-dimensional mask that splits open toward left and right is provided for wearing. In a shielding region of mask body corresponding to a user's mouth, a refractive diaphragm is replaceably disposed and is expanded associatively following a preparation operation. The present invention also provides a three-dimensional mask by which the expression of the user's mouth can be manifested, and a manufacturing method and production equipment of that three-dimensional mask.

### b) Description of the Prior Art

A three-dimensional mask is usually formed by a mask body, with two sides thereof being connected with an ear-hook element. The mask body is expanded toward left and right against a central longitude, to manifest a state of readiness for use. A front side of that state of readiness for use looks like a shield, and an inner skin-friendly side is a three-dimensional arch-shaped space that can be covered on a curved surface of the user's nose and mouth, and can be used to filter air for breathing.

The mask body is formed by overlapping fabric, and includes an outer shielding layer, an intermediate layer and an inner lining layer for filtering bacteria, according to the need of use. Therefore, an all-cover mask body is formed, i.e., the user's nose and mouth are completely shielded that the user's verbal expression cannot be manifested.

### SUMMARY OF THE INVENTION

A three-dimensional mask with an expression window, and a manufacturing method and production equipment thereof are disclosed; wherein a three-dimensional mask that splits open toward left and right as a bulge is provided for wearing. In a shielding region of mask body corresponding to a user's mouth, a refractive diaphragm is replaceably and tightly disposed and is expanded associatively following a preparation operation, so that a person with whom the user communicates can see through the expression of the user's mouth and the verbal the user manifests. A primary object of the present invention is to provide a three-dimensional mask for context communication, and a coherent manufacturing method as well as production equipment thereof, with some devices of the production equipment being able to be adapted in a same working region.

A second object of the present invention is to disclose a three-dimensional mask with an expression window, and a manufacturing method and production equipment thereof; wherein the refractive diaphragm is combined with a shaped hole, by welding sewing contours on the peripheries of refractive diaphragm and shaped hole.

A third object of the present invention is to disclose a three-dimensional mask with an expression window, and a manufacturing method and production equipment thereof; wherein a center of the refractive diaphragm, corresponding to the longitude, is provided with a chain line to expand an operational pivot. The chain line can be formed by a longitudinal folding line, which is welded with a longitudinal full sewing line integrally or is extended and welded with a longitudinal jaw sewing line.

A fourth object of the present invention is to disclose a three-dimensional mask with an expression window, and a manufacturing method and production equipment thereof; wherein in the longitude, a body linking line is separated, or a longitudinal folding line formed by bending a body of the refractive diaphragm is separated.

A fifth object of the present invention is to disclose a three-dimensional mask with an expression window, and a manufacturing method and production equipment thereof; wherein, the body linking line is disposed on an upper end of the longitude, and a nose bridge cleat is laterally disposed at the height of the body linking line to be combined on the breadth of mask body.

A sixth object of the present invention is to disclose a three-dimensional mask with an expression window, and a manufacturing method and production equipment thereof. The production equipment that is used in accordance with the manufacturing method of the present invention, is arranged according to the process with following devices. An overlapped feeding device feeds out a running feed belt through a pinch operation. Next, an edge fixing and hole punching device and a film fixation device are provided. The film fixation device is provided with an alignment operation device and an edge welding device. Then, a folding device is provided with a guiding element that folds the running feed belt toward left and right against a folding base line provided on the running feed belt. After that, a longitude sewing device is provided with a welding unit, a roll cutting device is provided with a fusion cutting unit, and a residual removal device is provided with a peeling mechanism. In addition, before the pinch operation provided by the overlapped feeding device, a lead-in at included-angle device is further provided.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an external view of a three-dimensional mask, according to the present invention.

FIG. 1A shows an enlarged view of stacking relation of a mask body, according to the present invention.

FIG. 2 shows a flow diagram of an operational process (along with devices), according to the present invention.

FIG. 3 shows a view of working state for an edge fixing and hole punching operation, according to the present invention.

FIG. 4 shows a view of working state for a film fixation operation, according to the present invention.

FIG. 5 shows a view of working state for a folding operation, according to the present invention.

FIG. 6 shows a view of working state for a longitude sewing operation, according to the present invention.

FIG. 7 shows a view of working state for a roll cutting operation, according to the present invention.

FIG. 8 shows a schematic view of an accomplished three-dimensional mask, according to the present invention.

FIG. 9 shows another schematic view of the accomplished three-dimensional mask, according to the present invention.

FIG. 10 shows still another schematic view of the accomplished three-dimensional mask, according to the present invention.

FIG. 11 shows an additional schematic view of the accomplished three-dimensional mask, according to the present invention.

FIG. 12 shows further another schematic view of the accomplished three-dimensional mask, according to the present invention.

FIG. 13 shows an external schematic view of the three-dimensional mask which is provided with a nose bridge cleat, according to the present invention.

FIG. 14 shows another flow diagram of the operational process (along with devices), according to the present invention.

FIG. 15 shows a schematic view of the present invention that is combined with the nose bridge cleat.

FIG. 16 shows a side view of the three-dimensional mask that is provided with the nose bridge cleat, according to the present invention.

### DETAILED DESCRIPTION OF THE PREFERRED EMBODIMENTS

The present invention discloses a three-dimensional mask with an expression window, and a manufacturing method and production equipment thereof; wherein a three-dimensional mask that splits open toward left and right as a bulge is provided for wearing. In a shielding region of mask body corresponding to a user's mouth, a refractive diaphragm is replaceably and tightly disposed and is expanded associatively following a preparation operation, so that a person with whom the user communicates can see through the expression of the user's mouth and the verbal the user manifests. Therefore, a three-dimensional mask for context communication and a coherent manufacturing method as well as production equipment thereof are provided, with some devices of the production equipment being able to be adapted in a same working region.

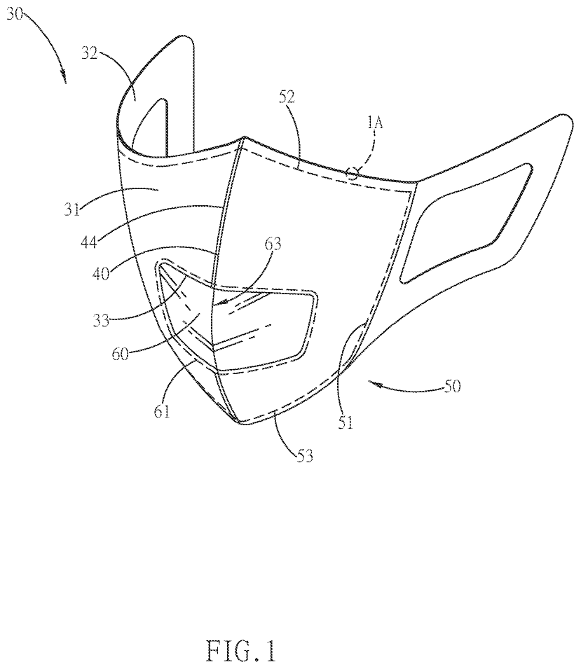

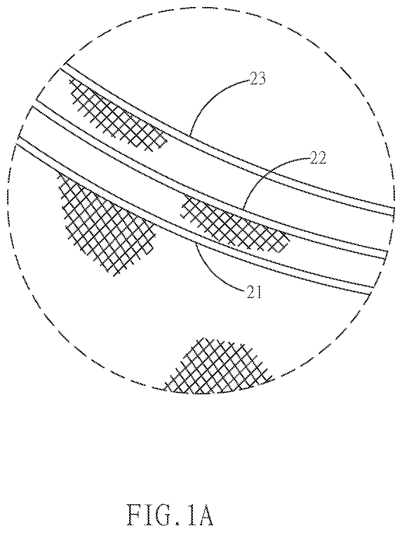

Please refer to FIG. 1 for a three-dimensional mask with an expression window, wherein a three-dimensional mask 30 provided by the present invention is formed selectively by stacking layers of fabric having various filtering functions, according to the need of filtering capacities. In the fabric stack, an outer shielding layer 21, an intermediate layer 22, and an inner lining layer 23 (in association with FIG. 1A) are compounded into a mask body 31. Two sides of the mask body 31 are connected respectively with an ear-hook element 32. A center of the mask body 31 is planned with a longitude 40 according to the curvature. The mask body 31 is a three-dimensional flat region, and an overlapped periphery thereof is sewn with a side sewing line 51, a cheek sewing line 52, and a jaw sewing line 53 provided by a contour sewing line 50. A shaped hole 33 is opened in the mask body 31 at a location corresponding to a user's mouth. The surface of shaped hole 33 is overlapped with a refractive diaphragm 60 which is flat melted with the periphery of shaped hole 33 through a sewing contour line 61. The linear location of the refractive diaphragm 60 corresponding to the longitude 40 is provided with a chain line 63; whereas, the sewing contour line 61 is sealed continuously in a linear fashion or is intermittently formed by segments.

The ear-hook elements 32 are combined with the mask body 31 by strings, which can be formed by extending out and cropping the outer shielding layer 21, the intermediate layer 22 or the inner lining layer 23. Or, the ear-hook elements 32 can use an independent elastic wiring (not shown in the drawings), with two ends of the wiring being hung up at an upper and lower corner on two sides of the mask body 31.

Please refer to FIG. 2 for the manufacturing method and production equipment of the three-dimensional mask with an expression window; wherein all operations are executed by the associated devices. The devices (not shown in the drawings) used in an overlapped feeding operation 11 feed out the outer shielding layer 21, the intermediate layer 22 and the inner lining layer 23. Before feeding out, a running feed belt 80 that is clamped into a stack by a pinch operation 24 is delivered toward an edge fixing and hole punching operation 12 to execute an edge fixing operation 121 and a hole punching operation 122. After that, the running feed belt 80 is delivered to a film fixation operation 13 which executes an alignment operation 131 and an edge melting operation 132. Next, the running feed belt 80 is folded by a folding operation 14. After being folded, the running feed belt 80 is performed with longitude sewing by a longitude sewing operation 15. After determining the curved longitude, a roll cutting operation 16 is performed to crop into a contour of the product. Finally, the product is separated out by a residual removal operation 17.

In the abovementioned process, an interior of the overlapped feeding device is provided with three pivots (not shown in the drawings) for pivoting the rolls of raw materials of the outer shielding layer 21, the intermediate layer 22 and the inner lining layer 23. The outer shielding layer 21, the intermediate layer 22 and the inner lining layer 23 are subjected to an external force and are clamped by a pinch device that is provided with a clamping rotor, forming a piece of stacked running feed belt 80 to be fed out.

The equipment of performing the edge fixing and hole punching operation 12 is provided with an edge fixing device and a hole punching device. The equipment of performing the film fixation operation 13 is provided with an alignment operation device and an edge melting device. The equipment of performing the folding operation 14 is provided with a guiding element in a shape of a guide plate. The guiding element folds the two sides of the running feed belt 80 obliquely using an operational center line of the running feed belt 80 as the working center.

The device of performing the longitude sewing operation 15 is provided with a hot-melting forming wheel. In the rolling process, protruded lines are arranged by the convex on the surface of forming wheel. In addition, multi-layer hot melting is performed onto the location of a matrix of dotted lines needed for hot melting in the running feed belt 80, with the heat energy coming from electric heating or ultrasonic vibration.

The equipment of performing the roll cutting operation 16 is provided with a rolling cutter in a shape of a wheel. The surface of the wheel is provided with blades corresponding to the locations of matrix of dotted lines to be cropped in the running feed belt 80, according to angles and perimeters. The blades conduct hobbing gradually to the range of length of the running feed belt 80 that traveks through the rolling cutter. The trimming action acquired from the hobbing can be cutting at a knife edge or hot-melting cropping, wherein in addition to the rolling cutter, the hobbing action can be also punching cropping by a contour-shaped forming knife.

The equipment of performing the residual removal operation 17 is provided with a peeling mechanism which can be a curled wheel with a same processing speed.

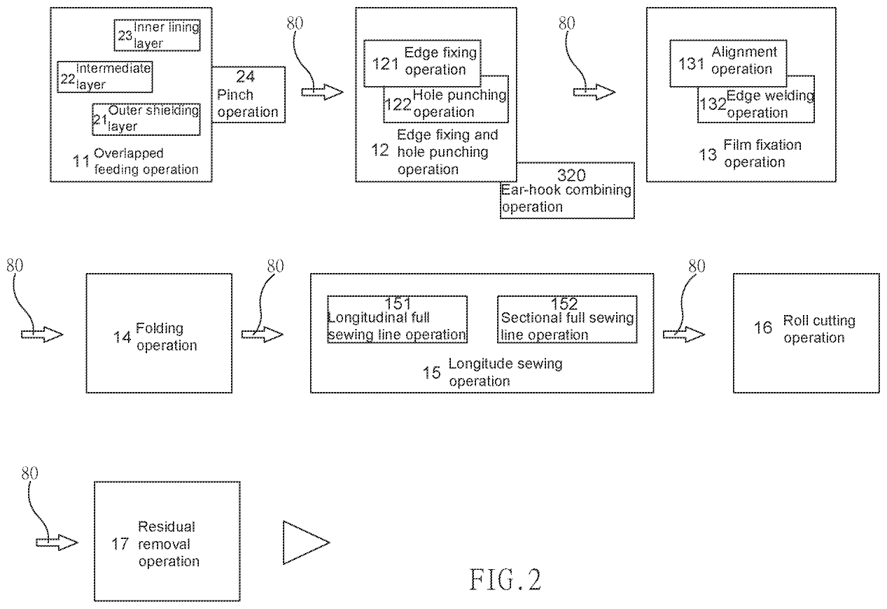

Please refer to FIG. 1 and FIG. 2 as a basis, along with FIGS. 3 to 7, for the detailed description of abovementioned manufacturing method and operations of associated equipment. Firstly, referring to FIG. 3 (along with FIG. 1 and FIG. 2), the process is operated according to the direction of arrows. In the edge fixing and hole punching operation 12, the associated devices are used to receive the running feed belt 80 fed from the overlapped feeding operation 11. A region 300 is setup in advance at a location where the three-dimensional mask 30 is expected to be formed. According to the definition of traveling direction of the running feed belt 80, the process starts at the melting of edge fixing operation 121, accomplishing gradually the side sewing line 51, the cheek sewing line 52 and the jaw sewing line 53, so as to complete the fixing of contour sewing line 50. The surface tension of region 300 is supported by the structure of contour sewing line 50, and at least after combining with the jaw sewing line 53, the sewing of side sewing line 51 and the opening of shaped hole 33 are executed simultaneously following the traveling direction. The opening of shaped hole 33 can be formed by roll cutting, and in the process, the sewing of side sewing line 51 is executed at a same time. The provided cheek sewing line 52 can be processed continuously following the previous sewing of jaw sewing line 53, forming a continuous operation.

The stacks of running feed belt 80 are formed by overlapping the outer shielding layer 21, the intermediate layer 22 and the inner lining layer 23. A center is defined with a folding base line L, and a body belt 81 in the center is formed by overlapping three layers. A side hanging strip 82 that is extended laterally is formed by extending the outer shielding layer 21, the intermediate layer 22, or the inner lining layer 23 toward two sides.

Referring to FIG. 4 (along with FIG. 1 and FIG. 2), for the region 300 that is accomplished with the sewing of contour sewing line 50 and the opening of shaped hole 33, the film fixation operation 13 to the refractive diaphragm 60 is then executed. Firstly, the film fixation operation 13 uses the associated devices to execute the alignment operation 131 to the refractive diaphragm 60 to be aligned exactly with the shaped hole 33. Next, the sewing contour line 61 is formed by executing the edge melting operation 132 on the periphery, so that the refractive diaphragm 60 can be combined flat with the periphery of mask body 31 by the sewing contour line 61.

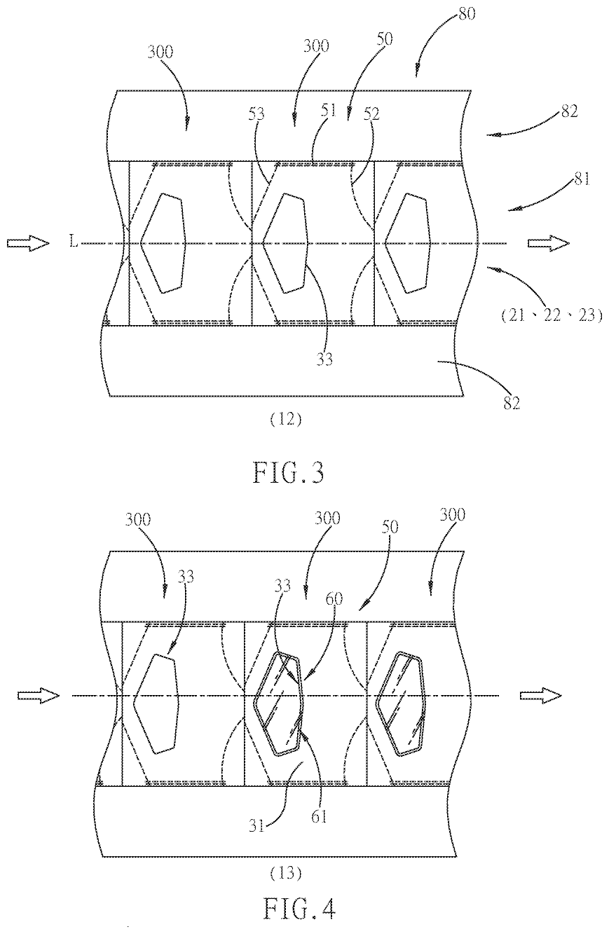

Referring to FIG. 5 (along with FIG. 1 and FIG. 2), in the folding operation 14, a guiding element (an oblique cutting, an inclined lever or a runner) provided by the devices guides the running feed belt 80 linearly, according to the location and direction of folding base line L, so that two sides of the running feed belt 80 are folded on one side along one direction. The folding base line L covers the parts of mask body 31 and the refractive diaphragm 60 that are expected to form the longitude 40.

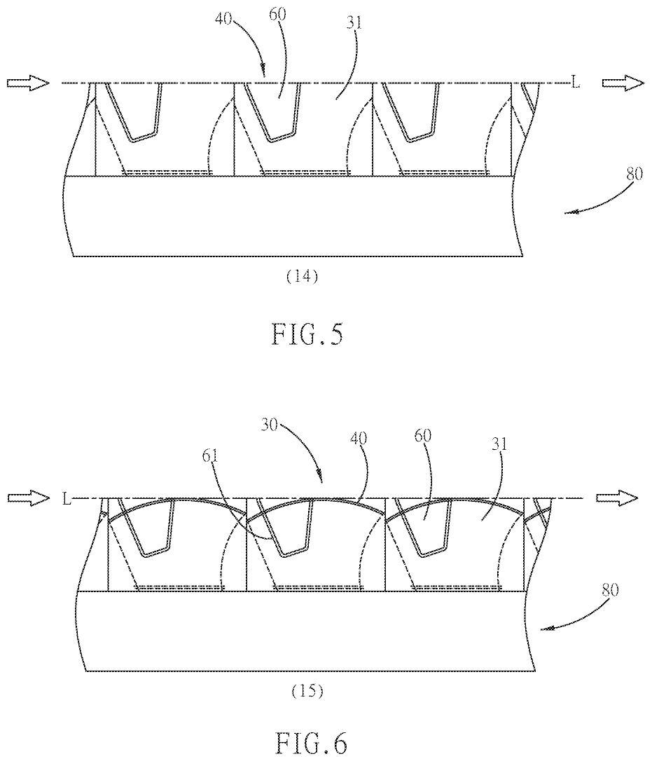

Referring to FIG. 6 (along with FIG. 1 and FIG. 2), to the abovementioned running feed belt 80 that is folded against the folding base line L, the longitude sewing operation 15 is executed on the location of longitude 40 that is expected to form the three-dimensional mask 30. The longitude sewing operation 15 is a longitudinal full sewing line operation 151 or a sectional full sewing line operation 152, determining the segment of longitude 40 and achieving melting to the sides of three-dimensional mask 30 and sewing contour line 61 facing the folding base line L. The device of longitude sewing operation 15 can be a hot-melting forming wheel, with protruded hot melting lines on a tread of the wheel performing a rolling hot-melting operation to a matrix of dotted lines on the running feed belt 80 that needs to be melted.

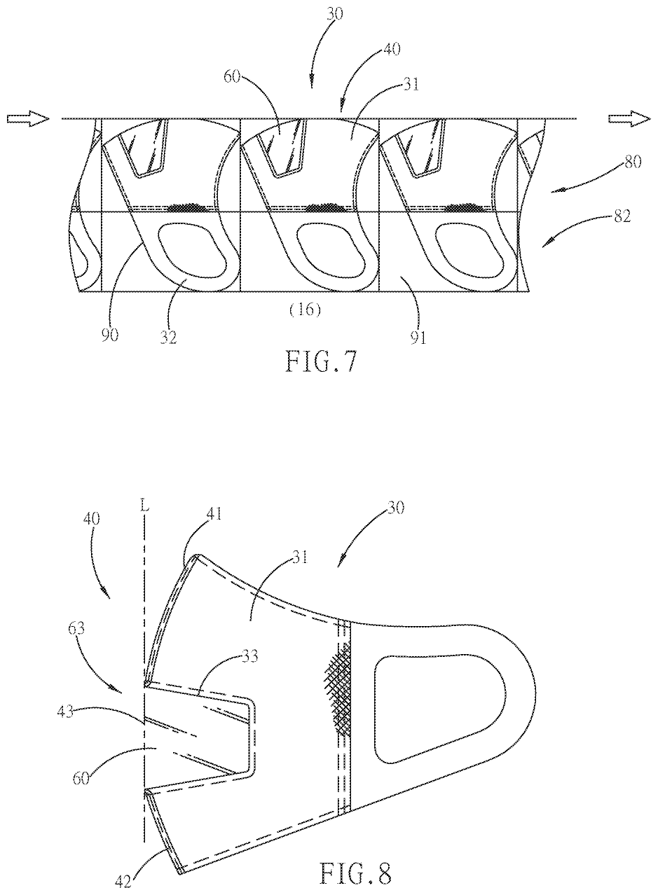

Referring to FIG. 7 (along with FIG. 1 and FIG. 2), after accomplishing the abovementioned melting of longitude 40, a contour cropping operation 90 is executed to the contour where the three-dimensional mask 30 is expected to be formed, wherein the roll cutting operation 16 can utilize the roll cutting on a circumference of a rolling cutter. In the process of contour cropping operation 90 by the roll cutting, the profile of ear-hook element 32 can be formed by rolling cut at a same time, including the formation of an ear-hook hole. Finally, a residual 91 is separated by the residual removal operation 17, wherein the separation extracts the accomplished body of three-dimensional mask 30.

By the side hanging strip 82 of the running feed belt 80, a striped ear-hook element 32 can be made through the planning of contour cropping operation 90. If the ear-hook element 32 is an independent single body of wire and is added externally on two sides of the mask body 31, then in the process (as shown in FIG. 2), a same working region of the edge fixing and hole punching operation 12 can be added with an independent wire-like ear-hook combining operation 320. The independent wire-like ear-hook is an ordinary hanging strip, hanging rope or alike that is not shown in the drawings. Two ends of the wire are combined respectively on an upper and lower end on two sides of the mask body 31.

The structure type formed for the three-dimensional mask 30 accomplished by the abovementioned steps can be shown in FIGS. 8 to 12, based on FIG. 1 and FIG. 2. Firstly, referring to FIG. 8, a shaped hole 33 is opened on the mask body 31 of three-dimensional mask 30 corresponding to a user's mouth. The shaped hole 33 is attached with a refractive diaphragm 60, and the location of overlapped longitude 40 on the refractive diaphragm 60 is provided with a chain line 63. The chain line 63 is formed by a longitudinal folding line 43 that is folded directly at a linear location of body center of the refractive diaphragm 60 facing exactly the folding base line L. An upper end of the longitudinal folding line 43 is connected with a longitudinal nose sewing line 41, and a lower end is connected with a longitudinal jaw sewing line 42.

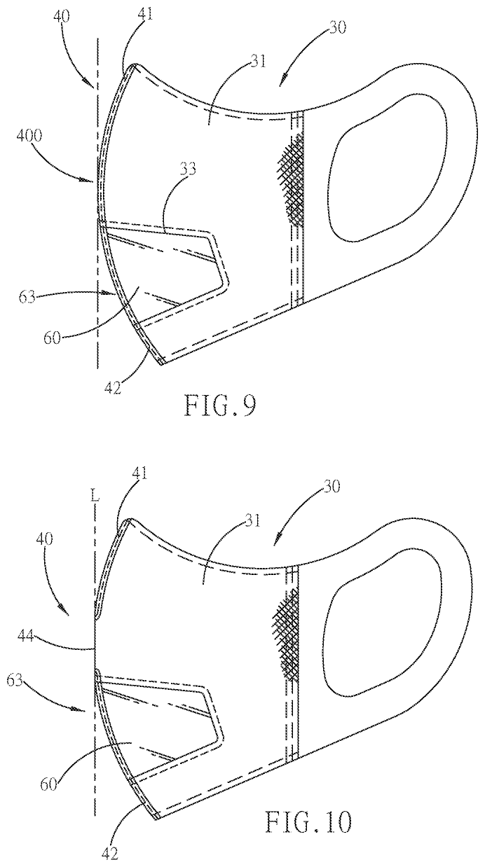

Referring to FIG. 9 (along with FIG. 2), the shaped hole 33 that is opened on the mask body 31 of three-dimensional mask 30 is attached with the refractive diaphragm 60. The chain line 63 on the refractive diaphragm 60 at a side of the longitude 40 is formed by melting through a longitudinal full sewing line 400 from top to bottom. The longitudinal full sewing line 400 is connected with the longitudinal nose sewing line 41, the chain line 63 and the longitudinal jaw sewing line 42; this operation is at the longitude sewing operation 15 in the process.

Referring to FIG. 10 (along with FIG. 2), the mask body 31 of three-dimensional mask 30 is attached with the refractive diaphragm 60. The chain line 63 of the refractive diaphragm 60 is formed by connecting upward the longitudinal jaw sewing line 42 that is operated by the longitude sewing operation 15. An upper end of the chain line 63 goes through a body linking line 44 that is overlapped on the folding base line L and is connected oppositely at a center of two sides of the mask body 31, and is then connected upward with the longitudinal nose sewing line 41, thereby constituting an intermittent longitude 40.

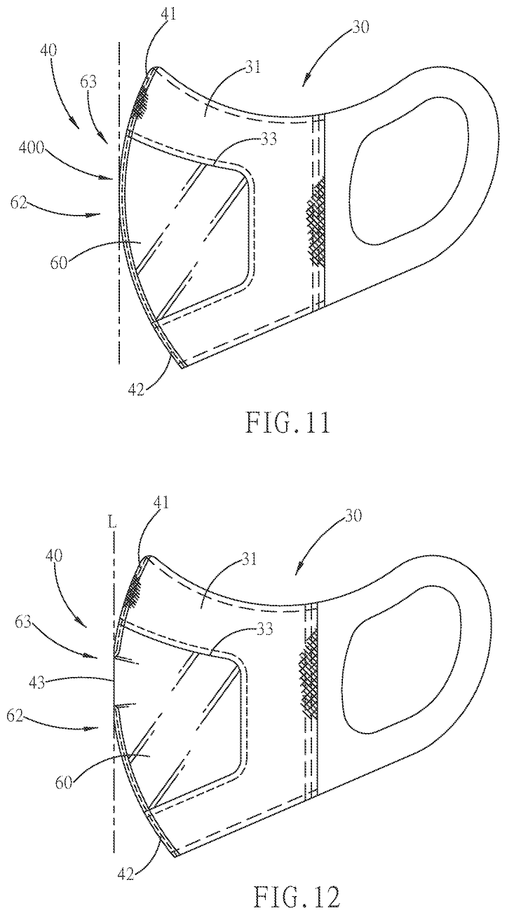

Referring to FIG. 11 (along with FIG. 2), the breadth of three-dimensional mask 30 is opened with a large shaped hole 33; and an interior of the shaped hole 33 is attached with a large refractive diaphragm 60. An upper part of the refractive diaphragm 60 provides for seeing through a user's nose, and a longitudinal side 62 of the refractive diaphragm 60 is a chain line 63 that is formed by melting together the longitudinal full sewing line 400, the longitudinal nose sewing line 41 and the longitudinal jaw sewing line 42 that form the longitude 40. The operation is based upon the process of longitude sewing operation 15.

Referring to FIG. 12, the large shaped hole 33 that is opened on the breath of three-dimensional mask 30 is attached with the large refractive diaphragm 60. On the refractive diaphragm 60 that is overlapped with the folding base line L, a longitudinal folding line 43 is formed reservedly to form the chain line 63. The longitudinal folding line 43 is connected upward with the longitudinal nose sewing line 41, and is connected downward with the longitudinal jaw sewing line 42. The lengths of longitudinal nose sewing line 41 and longitudinal jaw sewing line 42 are extended respectively to an upper and lower end of the longitudinal folding line 43. The longitudinal folding line 43 is a center section that is overlapped with the folding base line L.

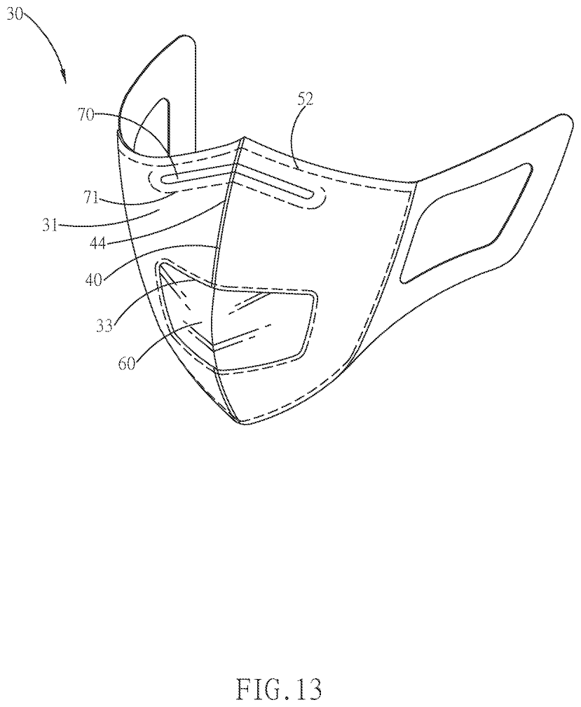

Referring to FIG. 13, the breadth of mask body 31 of three-dimensional mask 30 is opened with the shaped hole 33 to be attached by the refractive diaphragm 60. An upper end of the longitude 40 is a body linking line 44 that is formed by bending the mask body 31 on two sides. The body linking line 44 can face exactly the longitudinal location of the user's nose bridge. In a height of the body linking line 44, a nose bridge cleat 70 is laterally disposed and is combined by a welding line 71. The three-dimensional mask 30 that is attached with the nose bridge cleat 70 provides for adjusting the body linking line 44 and the breadths on two sides, so that the three-dimensional mask 30 can be more tightly attached on the outer surface of the user's nose, after the user wears the three-dimensional mask 30.

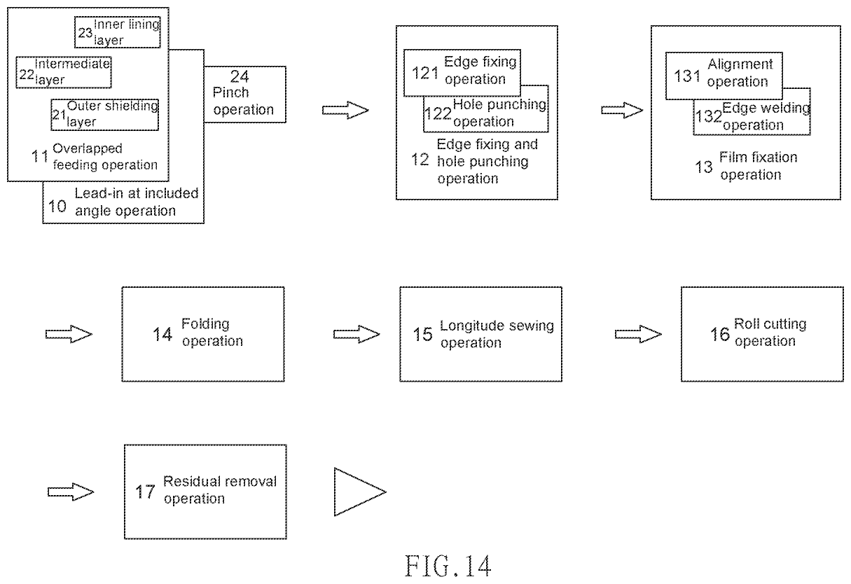

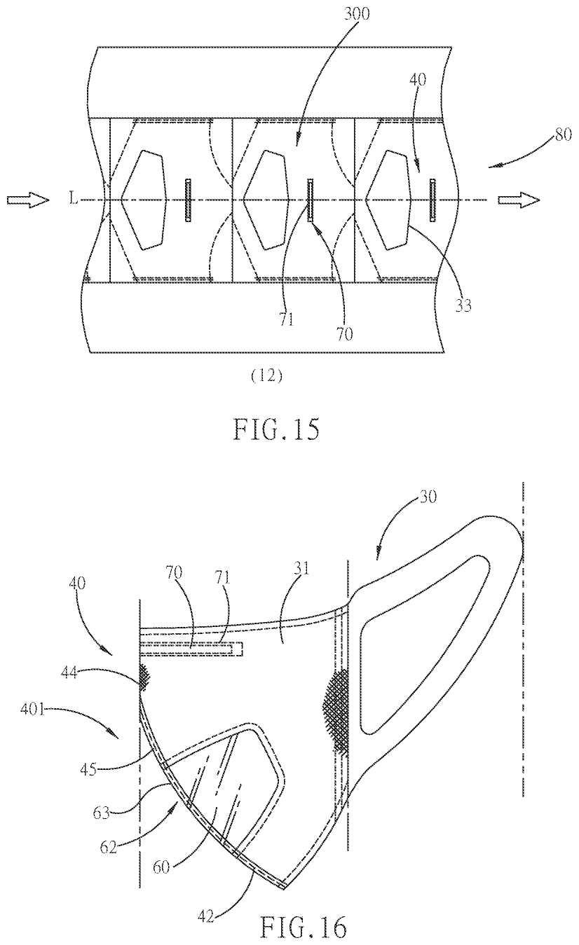

Please refer to FIG. 14 for the manufacturing process of nose bridge cleat 70. After the overlapped feeding operation 11 and before the pinch operation 24, a lead-in at included angle operation 10 to the nose bridge cleat 70 is executed in the included angle of the pinch operation 24 that the outer shielding layer 21, the intermediate layer 22 and inner lining layer 23 are fed in. The lead-in at included angle operation 10 utilizes a tipping action of the associated device to overlap the nose bridge cleat 70 into the outer shielding layer 21, the intermediate layer 22, or the inner lining layer 23. Please refer to FIG. 15 (along with FIG. 14) for the status, wherein the nose bridge cleat 70 is clamped in the region 300 close to an upper end of the longitude 40, and is horizontal to the folding base line L. After the nose bridge cleat 70 is combined by the welding line 71, the edge fixing and hole punching operation 12 is executed, wherein by the combination of the nose bridge cleat 70, the shaped hole 33 can be opened more stably without being affected by the change in tension.

Referring to FIG. 16 (along with FIG. 14), by the abovementioned manufacturing method, for the three-dimensional mask 30, an upper end of the longitude 40 is a body linking line 44 that is formed by extending the mask body 31 on two sides. The height space of the body linking line 44 is laterally combined with the nose bridge cleat 70, and the longitudinal side 62 of the refractive diaphragm 60, the nose sewing line 45 and the longitudinal jaw sewing line 42 are executed together by the longitude sewing operation 15 from a sectional full sewing line 401. An outer side of the refractive diaphragm 60 is formed with the chain line 63, and the nose sewing line 45 is connected upward with the body linking line 44. The body linking line 44 is flat after being expanded. As the mask body 31 is soft in texture, and with the help of nose bridge cleat 70, the attachment onto the curve of the user's nose bridge can be increased.

The present invention utilizes a coherent method and devices to produce rapidly the three-dimensional mask with an expression window. By a minor tuning to the manufacturing method, three-dimensional masks in plural kinds can be manufactured. Therefore, the present invention is a brand new mask design, manufacturing method and equipment thereof.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A three-dimensional mask with an expression window, comprising
a mask body, which is overlapped in plural layers, with a periphery of the mask body being sewn by a contour sewing line, a center of the breadth of the mask body being provided with a longitude, a location of the breadth corresponding to a user's mouth splitting open with a shaped hole toward left and right based on the longitude;
a flexible refractive diaphragm being larger than the shaped hole in the shape of contour, with the refractive diaphragm being tightly attached onto the periphery of shaped hole by a sewing contour, and a center of the breadth facing exactly the longitude being formed with a chain line; and
a set of ear-hook element which is combined on a side of the mask body.

2. The three-dimensional mask with an expression window, according to claim 1, wherein the sewing contour line is closed or densely intermittent.

3. The three-dimensional mask with an expression window, according to claim 1, wherein the chain line provided by the refractive diaphragm is a longitudinal folding line.

4. The three-dimensional mask with an expression window, according to claim 1, wherein the chain line provided by the refractive diaphragm is formed by welding an entire longitudinal full sewing line.

5. The three-dimensional mask with an expression window, according to claim 1, wherein the chain line provided by the refractive diaphragm is formed by welding a longitudinal jaw sewing line upward.

6. The three-dimensional mask with an expression window, according to claim 1, wherein the longitude is formed by a longitudinal nose sewing line which is connected downward with a longitudinal jaw sewing line through a body linking line.

7. The three-dimensional mask with an expression window, according to claim 1, wherein the longitude is formed by a longitudinal nose sewing line that is extended into the longitudinal side provided by the refractive diaphragm, separated by a central longitudinal folding line on the longitudinal side, and being extended downward to connect with a longitudinal jaw sewing line.

8. The three-dimensional mask with an expression window, according to claim 1, wherein an upper end of the longitude is a body linking line which is linearly overlapped with the folding base line, and a lower end of the body linking line is connected downward with a sectional full sewing line to construct a longitude together.

9. The three-dimensional mask with an expression window, according to claim 8, wherein in a height region of the body linking line, a nose bridge cleat is laterally combined at the mask body.

10. A production equipment of a three-dimensional mask with an expression window, comprising
an overlapped feeding device, which is provided with a feeding route with plural layers and feeds out a running feed belt from a pinch operation;
an edge fixing and hole punching device, which is connected with a working path of the pinch operation;
a film fixation device, which is connected with a working path of the edge fixing and hole punching operation and is provided with an alignment operation unit and an edge melting operation unit;
a folding device, which is connected with a working path of the film fixation operation and is provided with a folding guiding element;
a longitude sewing operation device, which is connected with a working path of the folding operation and is provided with a welding unit;
a roll cutting operation device, which is connected with a working path of the longitude sewing operation and is provided with a fuse cutting unit; and
a residual removal operation device, which is connected with a working path of the roll cutting operation and is provided with a peeling mechanism.

11. The production equipment of the three-dimensional mask with an expression window, according to claim 10, wherein before the pinch operation, a lead-in at included angle device is provided, and the lead-in at included angle device is connected outward with a nose bridge cleat supplying unit.

12. A manufacturing method of a three-dimensional mask with an expression window, comprising
an overlapped feeding operation, which deploys plural layers of fabric and feeds out a running feed belt by the collection and clamping of a pinch operation, with the running feed belt being longitudinally defined with a folding base line at the center;
an edge fixing and hole punching operation, which executes a sequential and intermittent edge fixing and hole punching operation to the traveling running feed belt at a location which is expected to be formed with a mask body;
a film fixation operation, which extracts a refractive diaphragm and aligns the refractive diaphragm exactly with the breadth of shaped hole for positioning and combining;
a folding operation, which folds two sides of the running feed belt against the folding base line;
a longitude sewing operation, which melts the longitude;
a roll cutting operation, which crops the contour of the mask body; and
a residual removal operation, which separates out the finished mask body.

13. The manufacturing method of a three-dimensional mask with an expression window, according to claim 12, wherein the roll cutting operation crops an ear-hook element at a same time.

14. The manufacturing method of a three-dimensional mask with an expression window, according to claim 12, wherein a working region in the edge fixing and hole punching operation is compounded with an ear-hook combining operation.
